(19) United States
(12) Patent Application Publication
(10) Pub. No.: US 2025/0256388 A1
(43) Pub. Date: Aug. 14, 2025

(54) TRUSS-ASSEMBLY JIGGING PUCKS AND METHOD

(71) Applicant: Steven R. Weinschenk, Rochester, MN (US)

(72) Inventor: Steven R. Weinschenk, Rochester, MN (US)

(21) Appl. No.: 19/050,108

(22) Filed: Feb. 10, 2025

Related U.S. Application Data
(60) Provisional application No. 63/552,078, filed on Feb. 9, 2024.

(51) Int. Cl. B25H 1/10; B27F 7/15

(52) U.S. Cl. CPC B25H 1/10; B27F 7/155

(57) ABSTRACT

A jigging puck that includes a base plate; a key having a key-rotational axis; a lock-activation top plate that is affixed to the key; a shoulder bolt having a bolt-rotational axis; a detent plate that is affixed to the key; a spacer plate that surrounds the detent plate; the lock-bar top plate that is rotatable around the shaft of bolt; and the lock-bar bottom plate affixed to the bolt. The bolt extends from above the lock-bar top plate to the lock-bar bottom plate and holds the puck together. The lock-activation top plate and the key are rotated around the key-rotational axis, the bottom of the key forces the lock-bar top plate and the lock-bar bottom plate to rotate in opposite directions around the shaft of the bolt in a scissors motion to lock or unlock the puck to a slot of a truss-assembly table.

### CROSS-REFERENCE TO RELATED APPLICATIONS

This application claims priority benefit, under 35 U.S.C. § 119(e), of U.S. Provisional Patent Application 63/552,078, filed Feb. 9, 2024 by Steven R. Weinschenk and titled “TRUSS-ASSEMBLY JIGGING PUCK AND METHOD,” which is incorporated herein by reference in its entirety.

This application is related to:
U.S. patent application Ser. No. 15/093,732 filed Apr. 7, 2016 by Steven R. Weinschenk, et al., titled “DIGITAL PROJECTION SYSTEM AND METHOD FOR WORKPIECE ASSEMBLY” (which issued as U.S. Pat. No. 10,210,607 on Feb. 19, 2019);
U.S. patent application Ser. No. 15/408,369 filed Jan. 17, 2017 by Steven R. Weinschenk, titled “AUTOMATED SYSTEM AND METHOD TO ENHANCE SAFETY AND STRENGTH OF WOOD TRUSS STRUCTURES” (which issued as U.S. Pat. No. 10,239,225 on Mar. 26, 2019);
U.S. patent application Ser. No. 15/426,966 filed Feb. 7, 2017 by Steven R. Weinschenk, titled “AUTOMATED SYSTEM AND METHOD FOR LUMBER PICKING” (which issued as U.S. Pat. No. 10,493,636 on Dec. 3, 2019);
U.S. patent application Ser. No. 15/658,026 filed Jul. 24, 2017 by Steven R. Weinschenk, titled “AUTOMATED MULTI-HEADED SAW AND METHOD FOR LUMBER” (which issued as U.S. Pat. No. 10,207,421 on Feb. 19, 2019); and
U.S. patent application Ser. No. 16/671,982 filed Nov. 1, 2019 by Steven R. Weinschenk, titled “TRUSS JIGGING SYSTEM AND METHOD” (which issued as U.S. Pat. No. 11,426,857 on Aug. 30, 2022);
   each of which is incorporated herein by reference in its entirety.

### FIELD OF THE INVENTION

The present invention relates to devices and methods for truss manufacturing, and in particular to a truss-jigging system and method that includes lock-in-place jigging pucks that are placed in a slot and include a rotatable mechanism operable to unlock from a current location in the slot, be lifted out or moved along the slot by hand to another desired new location wherein the rotatable mechanism is operable lock the jigging puck to the new location, and in some embodiments, is set and released by a hammer strike rather than by a wrench. This hammer-strike design improves efficiency and prolongs the life of the puck by isolating the critical truss-board-locating surfaces from direct hammer impacts; the system optionally includes a location-measuring subsystem (such as a machine-vision system that communicates data such as by projecting image information onto the slotted truss-assembly table, for use by an operator, and/or moved to a location-indicating fiducial system engraved in the slot that is readable by the operator using the jigging puck). Some embodiments include a camera (or other imaging system) that provides feedback as to the current location of the jigging puck and optionally sends commands to the operator to unlock, readjust the position of the jigging puck, and re-lock at the adjusted position.

### BACKGROUND OF THE INVENTION

Conventional jig-setting systems position lumber pieces on a truss-assembly table using pin carriages or pucks that are moved across the top surface of the slotted truss-assembly table in X and/or Y directions with a screw or chain (the pin carriages or pucks include a pin sticking through the table surface to position the lumber). These conventional systems permanently locate the pin carriages/pucks in the truss-assembly table so a lower-usage part of the truss-assembly table often has very expensive jigging sitting unused until a rare, larger truss needs to be built (e.g., the expensive rails of conventional systems are commonly in a location that is rarely used such as a normal parking spot for a roller gantry). Some conventional systems install a pin carriage/puck every two feet.

Wood-roof-truss tables are commonly provided with multiple slots into which jigging pucks are inserted to define the perimeter of a truss. The proper positioning of these pucks is critical for ensuring that multiple trusses are built to the same dimensions. Conventional jigging pucks require the use of a wrench to set or release the puck. In many worksites, the wrench is often located away from the truss assembly area, necessitating unnecessary delays as workers retrieve the tool. Additionally, some existing designs include a clamping element that fits under the slot to provide holding force, making manual removal cumbersome.

U.S. Pat. No. 8,109,493 by Jerome E. Koskovich, et al., titled “AUTOMATED TRUSS ASSEMBLY JIG SETTING SYSTEM,” issued on Feb. 7, 2012, and is incorporated herein by reference. U.S. Pat. No. 8,109,493 describes a retrofitted automated truss assembly jig setting system and one or more removable plank units used therewith. Removable plank unit includes a pair of drive motors each connected to a motor plate that is fixed to the bottom surface of a plank. A pair of rods extends along the length of the plank and each is operatively connected to a motor such that activation of a motor rotates a rod. Puck assemblies are carried by rods and are linearly transposed along rods when motors are activated. A computerized control system is operatively connected to provide for automated positioning of pucks. Planks on existing truss assembly tables may be removed and replaced with removable plank units to turn a traditional truss assembly jigging table into an automated truss assembly jigging table.

U.S. Pat. No. 9,821,440 by Clyde R. Fredrickson, et al., titled “AUTOMATIC TRUSS JIG SETTING SYSTEM,” issued on Nov. 21, 2017, and is incorporated herein by reference. U.S. Pat. No. 9,821,440 describes an automatic truss jig setting system that includes a table including a plurality of segments with a side edge of adjacent segments defining a slot. At least one pin assembly, and optionally a pair of pin assemblies, is movable independently of each other along the slot. Movement apparatus is provided for independently moving the pin assemblies along the slot. Each of the side edges of the segments associated with the slot defines a substantially vertical plane with a zone being defined between the substantially vertical planes of the side edges, and the movement apparatus is located substantially outside of the zone of the slot. The U.S. Pat. No. 9,821,440 invention may optionally include a system for handling the obstruction of pin assembly movement, and a system for keeping track of the position of the pin assembly when the pin assembly has encountered an obstruction.

U.S. Pat. No. 10,460,880 to Snyder issued Oct. 29, 2019 with the title “Capacitors having engineered electrodes with very high energy density and associated method” and is incorporated herein by reference. U.S. Pat. No. 10,460,880 describes an apparatus and associated method for an energy-storage device (e.g., a capacitor) having a plurality of electrically conducting electrodes including a first electrode and a second electrode separated by a non-electrically conducting region, and wherein the non-electrically conducting region further includes a non-uniform permittivity (K) value. In some embodiments, the method includes providing a substrate; fabricating a first electrode on the substrate; and fabricating a second electrode such that the second electrode is separated from the first electrode by a non-electrically conducting region, wherein the non-electrically conducting region has a non-uniform permittivity (K) value. The capacitor devices will find benefit for use in electric vehicles, of all kinds, uninterruptible power supplies, wind turbines, mobile phones, and the like requiring wide temperature ranges from several hundreds of degrees C. down to absolute zero, consumer electronics operating in a temperature range of −55 degrees C. to 125 degrees C.

Operators sometimes resort to striking the puck with a hammer to dislodge it, thereby inadvertently damaging the critical board-locating surfaces. This practice shortens the lifespan of the puck and compromises accuracy over time. Thus, there is a clear need for an improved jigging puck.

### SUMMARY OF THE INVENTION

In some embodiments, the present invention provides a hammer-lockable jigging puck 700 (See FIGS. 7A-7J) for use in wood roof truss tables that overcomes the disadvantages of prior art devices, since the present jigging puck can be set and released rapidly using a hammer (a tool readily available to every builder), eliminates the need for a wrench, provides secure clamping by engaging the side walls of the slot, protects the critical surfaces from direct impact damage, and facilitates easy manual removal. The jigging puck includes a robust body featuring:
a board-locating surface that defines the perimeter of a wood truss,
a hammer-actuatable clamping mechanism that engages the side walls of a truss table slot, and
a hammer-actuation surface that is purposely isolated from the truss-defining board-locating surface so that the impact used to set or release the puck does not damage the truss-defining surfaces. In some embodiments, resilient clamping members (such as flexible flanges or spring-like elements) extend from the body so that when a hammer strike is applied to the designated hammer-actuation surface, these members expand, rotate or pivot to grip the side walls of the slot firmly. A subsequent hammer strike on an opposing surface of the hammer-actuation surface or the natural elastic recovery of the clamping members releases the puck, permitting manual removal.

This design not only speeds up the truss assembly process by eliminating the need for a wrench, but also ensures that the critical alignment surfaces remain undamaged by repeated hammering. As a result, truss members consistently contact the jigging puck in the desired manner, ensuring uniform truss dimensions and shape and enhanced operational efficiency.

In some embodiments, a different version, jigging puck 101, of the present invention includes a base plate 110, a lock top plate 120 that is affixed to key 140 (e.g., in some embodiments, by welding), a shoulder bolt 130 having a vertical bolt axis 139, a spacer plate 150, that surrounds a detent plate 160 that is also affixed to key 140 (e.g., in some embodiments, by welding), a lock-bar top plate 170 that is rotatable around a shaft of bolt 130, and a lock-bar bottom plate 180 that is affixed to bolt 130 (e.g., in some embodiments, by a threaded interface, or in other embodiments, by welding). In some embodiments, each of the above listed parts of jigging puck 101 are made of a suitable metal such as steel. In some embodiments, key 140 has a vertical rotation axis 149, and key 140, detent plate 160, and lock-activation top plate 120 rotate as a unit around the vertical key rotation axis 149. In operation, the lower portion of jigging puck 101 extends into a slot of a truss-assembly table, such that when lock-activation top plate 120 is rotated to a first unlock position, key 140 is in a neutral rotary position relative to lock-bar top plate 170 and lock-bar bottom plate 180 so that lock-bar top plate 170 and lock-bar bottom plate 180 are relatively aligned with one another and they are not urged against the sides of the slot into which jigging puck 101 is partially inserted. Then, when an operator (such as a human) rotates lock-activation top plate 120 around the vertical key rotation axis 149 (such as by rotating by hand, or with a tool such as a hammer or a wrench), the lower portions 147 and 148 of key 140 press against respective portions of lock-bar top plate 170 and lock-bar bottom plate 180, forcing lock-bar top plate 170 and lock-bar bottom plate 180 to rotate in opposite directions around vertical bolt axis 139 to an X-shaped configuration with opposite ends of both lock-bar top plate 170 and lock-bar bottom plate 180 pressed against the sides of the slot each urged with relatively similar or the same force, effectively “locking” the jigging puck 101 in place in the slot.

The jigging pucks of the present invention are not permanent in the table so they can be re-positioned to other slots in the same truss setup or into another truss setup as needed.

In some enhanced embodiments, the pucks include a way to communicate their identification to the controlling system (e.g., flashing a pulse-encoded light signal from a top-side LED so that one or more overhead cameras can identify both which puck is flashing and what the location is of that puck) so that the control computer system can assign new locations on the slotted table depending on need in that area of the truss setup. In some embodiments, the pucks communicate with a controller connected to the overhead camera(s) to get a corrected position and the location where the pucks should be moved to and locked in that stopped location. In some embodiments, the pucks are able to go to the location by themselves using a self-contained power source and motorized actuators such as rubber wheels that press against the table inside or above or below the slot in the table. In some embodiments, the pucks have their own cameras or other imaging devices that look at the surroundings (such as ruled and encoded lines on the slot) to determine how far they have moved. For example, in some embodiments, the pucks are given a relative move distance and a direction from a controller via wireless communications such as infrared (IR), WIFI, Bluetooth® or similar such signals). In some embodiments, the pucks are given an absolute move, wherein electronic components of each puck (e.g., microprocessors, sensors, light emitters, sound emitters) determines the puck's location by tracking the objects above or beside the puck or from feedback from the other pucks on the truss-assembly table. In some embodiments, projectors located above the truss-assembly table project a line on the truss-assembly table and the puck senses and uses the projected line to position itself.

In some embodiments, the jigging pucks are electrically powered by rechargeable batteries. In some other embodiments, the jigging pucks are electrically powered by supercapacitors, since supercapacitors can be recharged in a shorter period of time than is possible if recharging batteries. In some such embodiments, the pucks are configured to automatically drive, under certain conditions (such as low on-board electrical power remaining in the batteries or supercapacitors) to a charging station, such as one or more located along an edge of the truss-assembly table (in some embodiments, the pucks are configured to stack against each other side-by-side in a slot connected to the recharging station to provide recharging power to multiple pucks in one slot at once). In other such embodiments, the pucks are pulled out of the truss-assembly table (e.g., by a human operator) and placed in a charging station. In some embodiments, the discharged batteries and/or supercapacitors are configured to be replaced by batteries and/or supercapacitors that were recharged outside the puck.

In some embodiments, the jigging pucks are elongated rectangular prisms with rounded ends or corners, while in other embodiments, the jigging pucks are elongated cylindrical prisms. In still other embodiments, the jigging pucks are square or triangular prisms or other-polyhedron prism shapes, optionally with rounded ends or corners.

### BRIEF DESCRIPTION OF THE FIGURES

FIG. 1A is a plan view of a jigging puck assembly 101, according to some embodiments of the present invention.

FIG. 1B is an edge cross-section view of jigging puck assembly 101, across section plane B shown in FIG. 1A, according to some embodiments of the present invention.

FIG. 1C is a cross-section view of jigging puck assembly 101, across section plane C shown in FIG. 1B, according to some embodiments of the present invention.

FIG. 1D is a cross-section view of jigging puck assembly 101, across section plane F′ shown in FIG. 1B, according to some embodiments of the present invention.

FIG. 1E is a cross-section view of jigging puck assembly 101, across section plane E shown in FIG. 1A, according to some embodiments of the present invention.

FIG. 1F is a cross-section view of jigging puck assembly 101, across section plane F shown in FIG. 1B, according to some embodiments of the present invention.

FIG. 1G is a cross-section view of jigging puck assembly 101, across section plane G shown in FIG. 1B, according to some embodiments of the present invention.

FIG. 1H is a cross-section view of jigging puck assembly 101, across section plane H shown in FIG. 1B, according to some embodiments of the present invention.

FIG. 1I is a cross-section view of jigging puck assembly 101, across section plane I shown in FIG. 1B, according to some embodiments of the present invention.

FIG. 1J is a first side view of jigging puck assembly 101 as viewed from the top side of FIG. 1L, according to some embodiments of the present invention.

FIG. 1K is a second side view of jigging puck assembly 101 as viewed from the left side of FIG. 1L, according to some embodiments of the present invention.

FIG. 1L is a top side plan view of jigging puck assembly 101, according to some embodiments of the present invention.

FIG. 1M is a third side view of jigging puck assembly 101 as viewed from the right side of FIG. 1L, according to some embodiments of the present invention.

FIG. 1N is a third side view of jigging puck assembly 101 as viewed from the bottom side of FIG. 1L, according to some embodiments of the present invention.

FIG. 1O is a bottom side plan view of jigging puck assembly 101, according to some embodiments of the present invention.

FIG. 1P is a top side perspective view of jigging puck assembly 101, according to some embodiments of the present invention.

FIG. 1Q is a top side perspective view of jigging puck assembly 101, according to some embodiments of the present invention.

FIG. 1R is a plan view of a jigging puck assembly 101, according to some embodiments of the present invention.

FIG. 1S is an edge cross-section view of jigging puck assembly 101, across section plane S shown in FIG. 1R, according to some embodiments of the present invention.

FIG. 2A is a more detailed cross-section view of jigging puck assembly 101, across section plane A shown in FIG. 1B, according to some embodiments of the present invention.

FIG. 2B is a more detailed cross-section view of jigging puck assembly 101, across section plane B shown in FIG. 2A, according to some embodiments of the present invention.

FIG. 2C is a more detailed cross-section view of jigging puck assembly 101, across section plane C shown in FIG. 2A, according to some embodiments of the present invention.

FIG. 2D is a more detailed cross-section view of jigging puck assembly 101, across section plane D shown in FIG. 2A, according to some embodiments of the present invention.

FIG. 2E is a more detailed cross-section view of jigging puck assembly 101, across section plane E shown in FIG. 2A, according to some embodiments of the present invention.

FIG. 2F is a more detailed cross-section view of jigging puck assembly 101, across section plane F shown in FIG. 2A, according to some embodiments of the present invention.

FIG. 2G is a more detailed a cross-section view of jigging puck assembly 101, across section plane G shown in FIG. 2A, according to some embodiments of the present invention.

FIG. 3 is a top view of a truss-assembly table 300, according to some embodiments of the present invention.

FIG. 4A is a top-left perspective view of a hammer-activated jigging puck 400, according to some embodiments of the invention.

FIG. 4B is a top view of hammer-activated jigging puck 400, according to some embodiments of the invention.

FIG. 4C is a top-right perspective view of hammer-activated jigging puck 400, according to some embodiments of the invention.

FIG. 4D is a rear-left elevation view of hammer-activated jigging puck 400, according to some embodiments of the invention.

FIG. 4E is a front elevation view of hammer-activated jigging puck 400, according to some embodiments of the invention.

FIG. 4F is a front-right elevation view of hammer-activated jigging puck 400, according to some embodiments of the invention.

FIG. 4G is a bottom-left perspective view of hammer-activated jigging puck 400, according to some embodiments of the invention.

FIG. 4H is a bottom view of hammer-activated jigging puck 400, according to some embodiments of the invention.

FIG. 4I is a bottom-right perspective view of hammer-activated jigging puck 400, according to some embodiments of the invention.

FIG. 5A is a top-left perspective view of a spring-loaded jigging puck 500, according to some embodiments of the invention.

FIG. 5B is a top view of spring-loaded jigging puck 500, according to some embodiments of the invention.

FIG. 5C is a top-right perspective view of spring-loaded jigging puck 500, according to some embodiments of the invention.

FIG. 5D is a left elevation view of spring-loaded jigging puck 500, according to some embodiments of the invention.

FIG. 5E is a front elevation view of spring-loaded jigging puck 500, according to some embodiments of the invention.

FIG. 5F is a right elevation view of spring-loaded jigging puck 500, according to some embodiments of the invention.

FIG. 5G is a bottom-left perspective view of spring-loaded jigging puck 500, according to some embodiments of the invention.

FIG. 5H is a bottom view of spring-loaded jigging puck 500, according to some embodiments of the invention.

FIG. 5I is a bottom-right perspective view of spring-loaded jigging puck 500, according to some embodiments of the invention.

FIG. 5J is a back elevation view of spring-loaded jigging puck 500, according to some embodiments of the invention.

FIG. 6A is a top-left perspective view of a spring-loaded jigging puck 600 with dash-dot lines not part of the claimed design, according to some embodiments of the invention.

FIG. 6B is a top view of a spring-loaded jigging puck 600, according to some embodiments of the invention.

FIG. 6C is a top-right perspective view of spring-loaded jigging puck 600, according to some embodiments of the invention.

FIG. 6D is a left elevation view of spring-loaded jigging puck 600, according to some embodiments of the invention.

FIG. 6E is a front elevation view of spring-loaded jigging puck 600, according to some embodiments of the invention.

FIG. 6F is a right elevation view of spring-loaded jigging puck 600, according to some embodiments of the invention.

FIG. 6G is a bottom-left perspective view of spring-loaded jigging puck 600, according to some embodiments of the invention.

FIG. 6H is a bottom view of spring-loaded jigging puck 600, according to some embodiments of the invention.

FIG. 6I is a bottom-right perspective view of spring-loaded jigging puck 600, according to some embodiments of the invention.

FIG. 6J is a back elevation view of spring-loaded jigging puck 600, according to some embodiments of the invention.

FIG. 7A is a top-left perspective view of a hammer-activated jigging puck 700, according to some embodiments of the invention.

FIG. 7B is a left elevation view of hammer-activated jigging puck 700, according to some embodiments of the invention.

FIG. 7C is a top-right perspective view of hammer-activated jigging puck 700, according to some embodiments of the invention.

FIG. 7D is a left elevation view of hammer-activated jigging puck 700, according to some embodiments of the invention.

FIG. 7E is a bottom view of hammer-activated jigging puck 700, according to some embodiments of the invention.

FIG. 7F is a right elevation view of hammer-activated jigging puck 700, according to some embodiments of the invention.

FIG. 7G is a bottom-left perspective view of hammer-activated jigging puck 700, according to some embodiments of the invention.

FIG. 7H is a right elevation of hammer-activated jigging puck 700, according to some embodiments of the invention.

FIG. 7I is a bottom-right perspective view of hammer-activated jigging puck 700, according to some embodiments of the invention.

FIG. 7J is a top view of hammer-activated jigging puck 700, according to some embodiments of the invention.

FIG. 8A is a top-left perspective view of hammer-blow-receiving block 710, according to some embodiments of the invention.

FIG. 8B is a left elevation view of hammer-blow-receiving block 710, according to some embodiments of the invention.

FIG. 8C is a top-right perspective view of hammer-blow-receiving block 710, according to some embodiments of the invention.

FIG. 8D is a left elevation view of hammer-blow-receiving block 710, according to some embodiments of the invention.

FIG. 8E is a bottom view of hammer-blow-receiving block 710, according to some embodiments of the invention.

FIG. 8F is a right elevation view of hammer-blow-receiving block 710, according to some embodiments of the invention.

FIG. 8G is a bottom-left perspective view of hammer-blow-receiving block 710, according to some embodiments of the invention.

FIG. 8H is a right elevation of hammer-blow-receiving block 710, according to some embodiments of the invention.

FIG. 8I is a bottom-right perspective view of hammer-blow-receiving block 710, according to some embodiments of the invention.

FIG. 8J is a top view of hammer-blow-receiving block 710, according to some embodiments of the invention.

FIG. 9A is a top-left perspective view of puck top 720, according to some embodiments of the invention.

FIG. 9B is a left elevation view of puck top 720, according to some embodiments of the invention.

FIG. 9C is a top-right perspective view of puck top 720, according to some embodiments of the invention.

FIG. 9D is a left elevation view of puck top 720, according to some embodiments of the invention.

FIG. 9E is a bottom view of puck top 720, according to some embodiments of the invention.

FIG. 9F is a right elevation view of puck top 720, according to some embodiments of the invention.

FIG. 9G is a bottom-left perspective view of puck top 720, according to some embodiments of the invention.

FIG. 9H is a right elevation of puck top 720, according to some embodiments of the invention.

FIG. 9I is a bottom-right perspective view of puck top 720, according to some embodiments of the invention.

FIG. 9J is a top view of puck top 720, according to some embodiments of the invention.

FIG. 10A is a top-left perspective view of hammer plate 730, according to some embodiments of the invention.

FIG. 10B is a left elevation view of hammer plate 730, according to some embodiments of the invention.

FIG. 10C is a top-right perspective view of hammer plate 730, according to some embodiments of the invention.

FIG. 10D is a left elevation view of hammer plate 730, according to some embodiments of the invention.

FIG. 10E is a bottom view of hammer plate 730, according to some embodiments of the invention.

FIG. 10F is a right elevation view of hammer plate 730, according to some embodiments of the invention.

FIG. 10G is a bottom-left perspective view of hammer plate 730, according to some embodiments of the invention.

FIG. 10H is a right elevation of hammer plate 730, according to some embodiments of the invention.

FIG. 10I is a bottom-right perspective view of hammer plate 730, according to some embodiments of the invention.

FIG. 10J is a top view of hammer plate 730, according to some embodiments of the invention.

FIG. 11A is a top-left perspective view of torque plate 740, according to some embodiments of the invention.

FIG. 11B is a left elevation view of torque plate 740, according to some embodiments of the invention.

FIG. 11C is a top-right perspective view of torque plate 740, according to some embodiments of the invention.

FIG. 11D is a left elevation view of torque plate 740, according to some embodiments of the invention.

FIG. 11E is a bottom view of torque plate 740, according to some embodiments of the invention.

FIG. 11F is a right elevation view of torque plate 740, according to some embodiments of the invention.

FIG. 11G is a bottom-left perspective view of torque plate 740, according to some embodiments of the invention.

FIG. 11H is a right elevation of torque plate 740, according to some embodiments of the invention.

FIG. 11I is a bottom-right perspective view of torque plate 740, according to some embodiments of the invention.

FIG. 11J is a top view of torque plate 740, according to some embodiments of the invention.

FIG. 12A is a top-left perspective view of flat-lock cam 750, according to some embodiments of the invention.

FIG. 12B is a left elevation view of flat-lock cam 750, according to some embodiments of the invention.

FIG. 12C is a top-right perspective view of flat-lock cam 750, according to some embodiments of the invention.

FIG. 12D is a left elevation view of flat-lock cam 750, according to some embodiments of the invention.

FIG. 12E is a bottom view of flat-lock cam 750, according to some embodiments of the invention.

FIG. 12F is a right elevation view of flat-lock cam 750, according to some embodiments of the invention.

FIG. 12G is a bottom-left perspective view of flat-lock cam 750, according to some embodiments of the invention.

FIG. 12H is a right elevation of flat-lock cam 750, according to some embodiments of the invention.

FIG. 12I is a bottom-right perspective view of flat-lock cam 750, according to some embodiments of the invention.

FIG. 12J is a top view of flat-lock cam 750, according to some embodiments of the invention.

FIG. 13A is a top-left perspective view of tongue tab 760, according to some embodiments of the invention.

FIG. 13B is a left elevation view of tongue tab 760, according to some embodiments of the invention.

FIG. 13C is a top-right perspective view of tongue tab 760, according to some embodiments of the invention.

FIG. 13D is a left elevation view of tongue tab 760, according to some embodiments of the invention.

FIG. 13E is a bottom view of tongue tab 760, according to some embodiments of the invention.

FIG. 13F is a right elevation view of tongue tab 760, according to some embodiments of the invention.

FIG. 13G is a bottom-left perspective view of tongue tab 760, according to some embodiments of the invention.

FIG. 13H is a right elevation of tongue tab 760, according to some embodiments of the invention.

FIG. 13I is a bottom-right perspective view of tongue tab 760, according to some embodiments of the invention.

FIG. 13J is a top view of tongue tab 760, according to some embodiments of the invention.

### COPYRIGHT NOTICE/PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described herein and in the drawings attached hereto: Copyright © 0 2024-2025, Steven R. Weinschenk, All Rights Reserved.

### DETAILED DESCRIPTION OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

It is specifically contemplated that the present invention includes embodiments having combinations and subcombinations of the various embodiments and features that are individually described herein (i.e., rather than listing every combinatorial of the elements, this specification includes descriptions of representative embodiments and contemplates embodiments that include some of the features from one embodiment combined with some of the features of another embodiment, including embodiments that include some of the features from one embodiment combined with some of the features of embodiments described in the patents and application publications incorporated by reference in the present application). Further, some embodiments include fewer than all the components described as part of any one of the embodiments described herein.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Certain marks referenced herein may be common-law or registered trademarks of third parties affiliated or unaffiliated with the applicant or the assignee. Use of these marks is for providing an enabling disclosure by way of example and shall not be construed to limit the scope of the claimed subject matter to material associated with such marks.

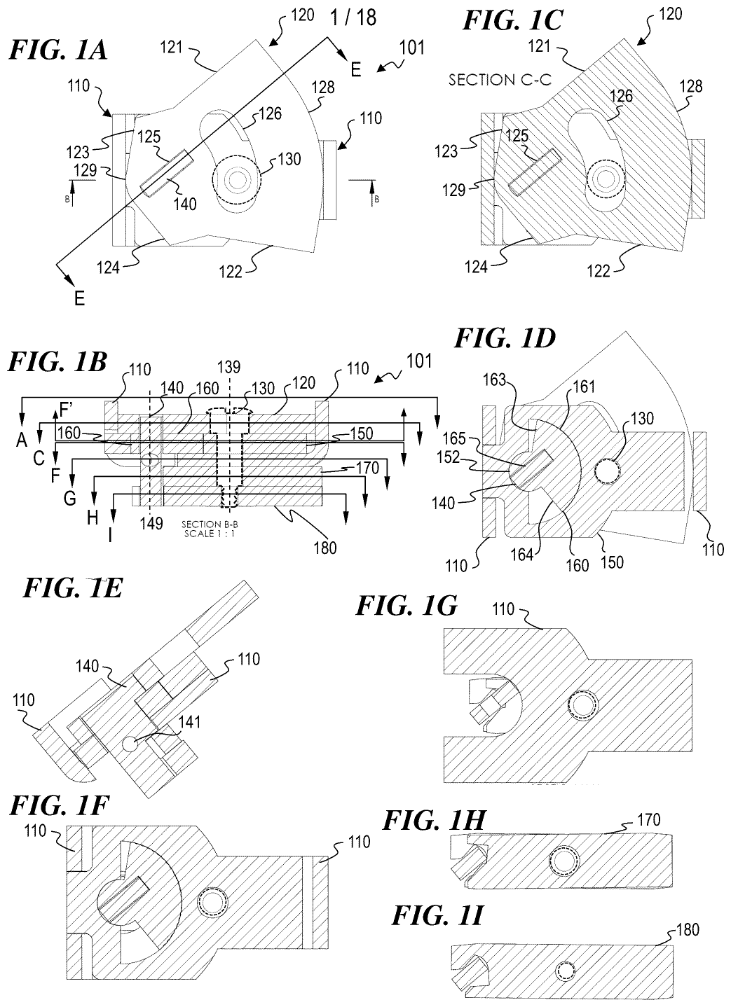

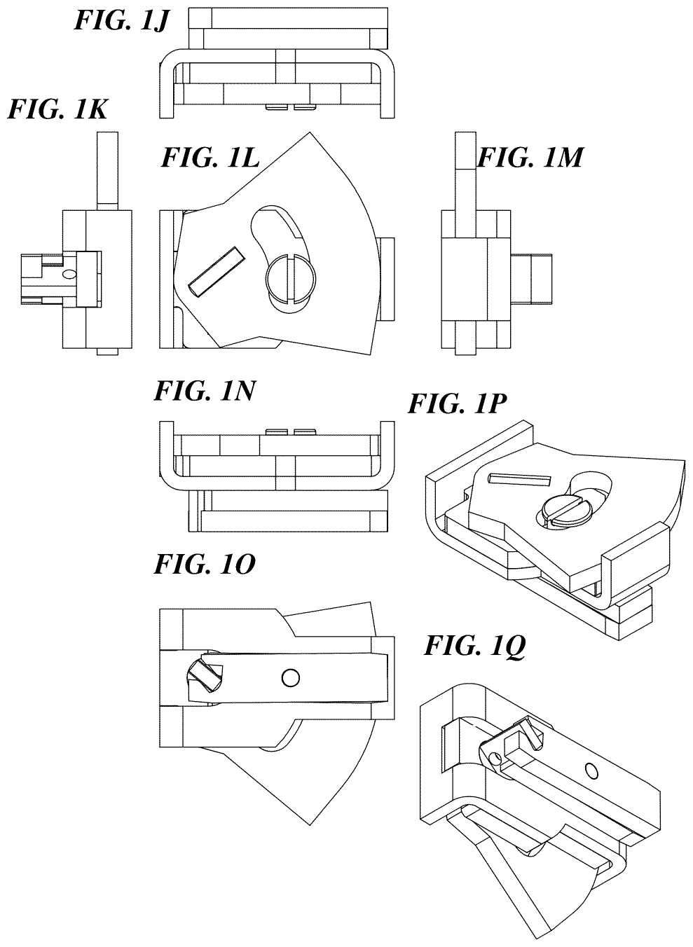

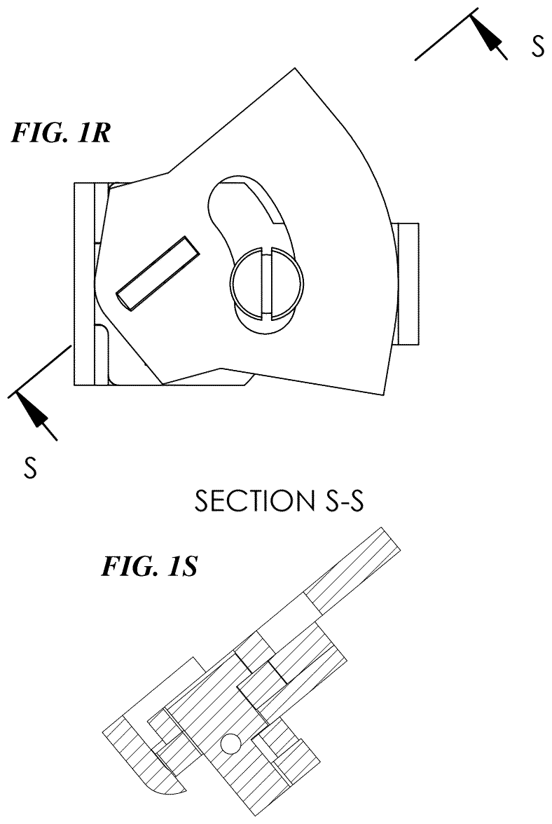

FIG. 1A is a plan view of a jigging puck assembly 101 (herein, also called jigging puck 101), according to some embodiments of the present invention. In some embodiments, the jigging puck 101 of the present invention includes a base plate 110, a lock-activation top plate 120 that is affixed to key 140 (e.g., in some embodiments, by welding), a shoulder bolt 130 having a vertical bolt axis 139, a spacer plate 150, that surrounds a detent plate 160 that is also affixed to key 140 (e.g., in some embodiments, by welding), a lock-bar top plate 170 that is rotatable around a shaft of bolt 130, and a lock-bar bottom plate 180 that is affixed to bolt 130 (e.g., in some embodiments, by a threaded interface, or in other embodiments, by welding). In some embodiments, each of the above listed parts of jigging puck 101 are made of a suitable metal such as steel. In some embodiments, key 140 has a vertical rotation axis 149, and key 140, detent plate 160, and lock-activation top plate 120 rotate as a unit around the vertical key rotation axis 149. In operation, the lower portion of jigging puck 101 extends into a slot of a truss-assembly table, such that when lock-activation top plate 120 is rotated to a first unlock position, key 140 is in a neutral rotary position relative to lock-bar top plate 170 and lock-bar bottom plate 180 so that lock-bar top plate 170 and lock-bar bottom plate 180 are relatively aligned with one another and they are not urged against the sides of the slot into which jigging puck 101 is partially inserted. Then, when an operator (such as a human) rotates lock-activation top plate 120 around the vertical key rotation axis 149 (such as by rotating by hand, or with a tool such as a hammer or a wrench), the lower portions 147 and 148 of key 140 press against respective portions of lock-bar top plate 170 and lock-bar bottom plate 180, forcing lock-bar top plate 170 and lock-bar bottom plate 180 to rotate in opposite directions around vertical bolt axis 139 to an X-shaped configuration with opposite ends of both lock-bar top plate 170 and lock-bar bottom plate 180 pressed against the sides of the slot each urged with relatively similar or the same force, effectively “locking” the jigging puck 101 in place in the slot.

In some embodiments, lock-activation top plate 120 includes a striking surface 121 configured to be struck by a hammer to rotate lock-activation top plate 120 to the locked position, and a striking surface 122 configured to be struck by a hammer to rotate lock-activation top plate 120 to the locked position. In other embodiments, some other tool, such as a wrench or even finger pressure can be used to rotate lock-activation top plate 120 to the locked or unlocked positions. In some embodiments, lock-activation top plate 120 includes a stop surface 123 that will be pressed against a corresponding surface of base plate 110 to limit counterclockwise rotation towards the unlocked position, and a stop surface 124 that will be pressed against a corresponding surface of base plate 110 to limit clockwise rotation towards the locked position. In some embodiments, lock-activation top plate 120 includes a rounded surface 128 that can travel along a corresponding surface of base plate 110 on the right side of FIG. 1A as lock-activation top plate 120 is rotated, and a rounded surface 129 that can travel along a corresponding surface of base plate 110 on the left side of FIG. 1A as lock-activation top plate 120 is rotated, both to help keep lock-activation top plate 120 relatively centered as lock-activation top plate 120 is being rotated. In some embodiments, lock-activation top plate 120 further includes a curved slot 126 in which bolt 130 travels (i.e., the slot 126 moves along a path guided by bolt 130), which also serves to help keep lock-activation top plate 120 relatively centered as lock-activation top plate 120 is being rotated.

FIG. 1B is an edge cross-section view of jigging puck assembly 101, across section plane B shown in FIG. 1A, according to some embodiments of the present invention. As shown here, in some embodiments, jigging puck 101 includes base plate 110, lock-activation top plate 120 that is affixed to key 140, shoulder bolt 130 having a vertical bolt axis 139, spacer plate 150, that surrounds rotating detent plate 160 that is also affixed to key 140, lock-bar top plate 170 that is rotatable around a shaft of bolt 130, and lock-bar bottom plate 180 that is affixed to bolt 130. When lock-activation top plate 120 is rotated, its attached key 140 acts to rotate lock-bar top plate 170 around a shaft of bolt 130 in a first direction, and lock-bar bottom plate 180 is rotated in the opposite direction to either lock jigging puck 101 to the sides of the slot in the truss-assembly when the X-shapes scissor action expands the X-shaped 170-180 combination or to unlock when the X-shaped 170-180 combination is relaxed or compressed to its neutral orientation.

FIG. 1C is a cross-section view of jigging puck assembly 101, across section plane C shown in FIG. 1B, primarily illustrating a cross section of lock-activation top plate 120, according to some embodiments of the present invention. The various reference numbers of lock-activation top plate 120 are explained in the description of FIG. 1A, above.

FIG. 1D is a cross-section view of jigging puck assembly 101, across section plane F′ shown in FIG. 1B, primarily illustrating cross sections of spacer plate 150 and rotating detent plate 160, according to some embodiments of the present invention. In some embodiments, rotating detent plate 160 includes a serrated or ridged features on the large arcuate outer-diameter surface 161 that interfaces with corresponding inner-diameter ridges on the inner surface 151 in the cutout of spacer plate 150. In some embodiments, rotating detent plate 160 includes a stop-surface 163 to limit the counterclockwise rotation of rotating detent plate 160 and a stop-surface 164 to limit the clockwise rotation of rotating detent plate 160. In some embodiments, rotating detent plate 160 includes a smaller-diameter curved surface 162 that mates against smaller-diameter curved surface 152 in the cutout of spacer plate 150, in order to guide the rotation of key 140 that is welded to the slot opening 165 rotating detent plate 160.

FIG. 1E is a cross-section view of jigging puck assembly 101, across section plane E shown in FIG. 1A, primarily illustrating a cross section of key 140, according to some embodiments of the present invention.

FIG. 1F is a cross-section view of jigging puck assembly 101, across section plane F shown in FIG. 1B, again primarily illustrating cross sections of spacer plate 150 and rotating detent plate 160, according to some embodiments of the present invention. As shown here, in some embodiments, key 140 has a cylindrical through hole 141, into which a retaining pin (not shown) can be inserted to help retain the parts in their operating configuration.

FIG. 1G is a cross-section view of jigging puck assembly 101, across section plane G shown in FIG. 1B, primarily illustrating a cross section of a bottom portion of base plated 110, according to some embodiments of the present invention.

FIG. 1H is a cross-section view of jigging puck assembly 101, across section plane H shown in FIG. 1B, primarily illustrating a cross section of lock-bar top plate 170 as well as the outer portion of lock-bar bottom plate 180, according to some embodiments of the present invention.

FIG. 1I is a cross-section view of jigging puck assembly 101, across section plane I shown in FIG. 1B, primarily illustrating a cross section of lock-bar bottom plate 180, according to some embodiments of the present invention.

FIG. 1J is a first side view of jigging puck assembly 101 as viewed from the top side of FIG. 1L, according to some embodiments of the present invention.

FIG. 1K is a second side view of jigging puck assembly 101 as viewed from the left side of FIG. 1L, according to some embodiments of the present invention.

FIG. 1L is a top side plan view of jigging puck assembly 101, according to some embodiments of the present invention.

FIG. 1M is a third side view of jigging puck assembly 101 as viewed from the right side of FIG. 1L, according to some embodiments of the present invention.

FIG. 1N is a third side view of jigging puck assembly 101 as viewed from the bottom side of FIG. 1L, according to some embodiments of the present invention.

FIG. 1O is a bottom side plan view of jigging puck assembly 101, according to some embodiments of the present invention.

FIG. 1P is a top side perspective view of jigging puck assembly 101, according to some embodiments of the present invention.

FIG. 1Q is a top side perspective view of jigging puck assembly 101, according to some embodiments of the present invention.

FIG. 1R is a plan view of a jigging puck assembly 101, according to some embodiments of the present invention.

FIG. 1S is an edge cross-section view of jigging puck assembly 101, across section plane S shown in FIG. 1R, according to some embodiments of the present invention.

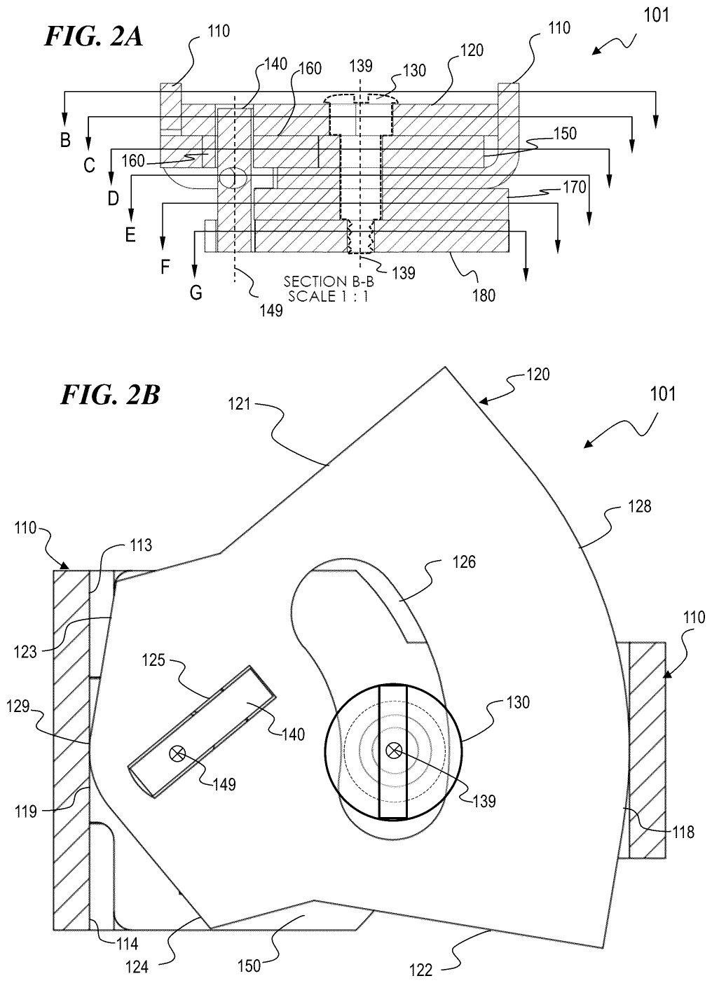

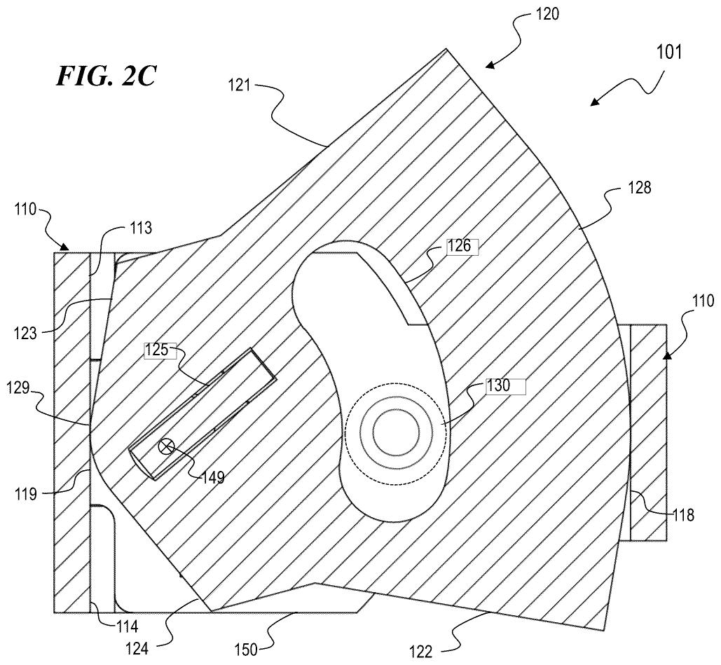

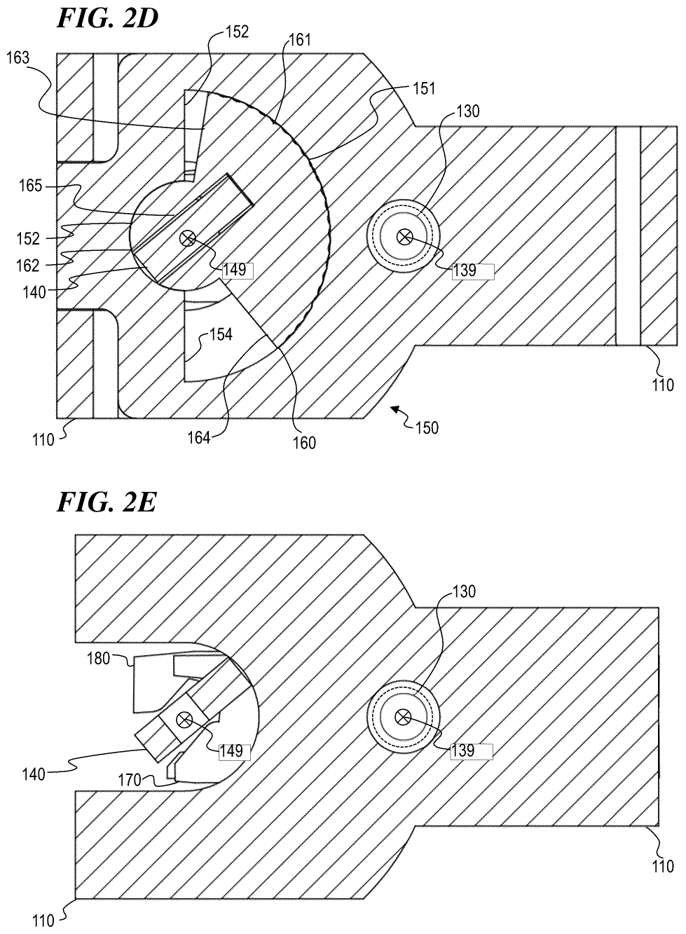

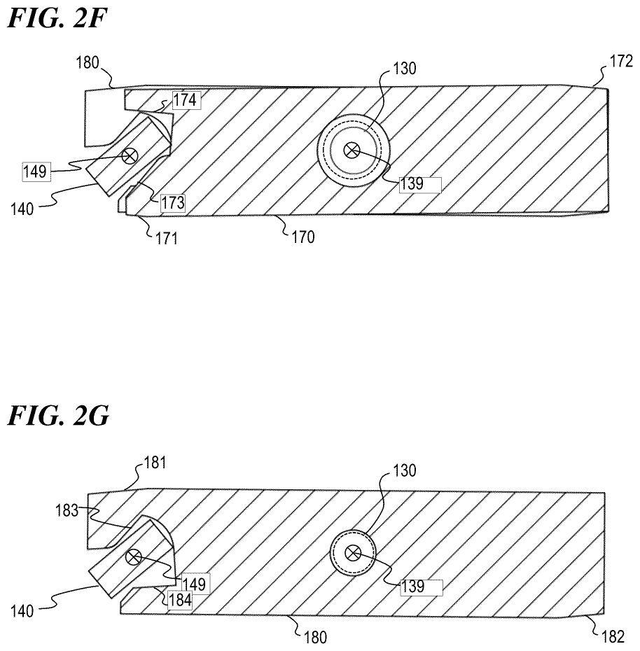

FIG. 2A is a more detailed cross-section view of jigging puck assembly 101, across section plane A shown in FIG. 1B, according to some embodiments of the present invention. As shown here, in some embodiments, jigging puck 101 includes base plate 110, lock-activation top plate 120 that is affixed to key 140, shoulder bolt 130 having a vertical bolt axis 139, spacer plate 150, that surrounds rotating detent plate 160 that is also affixed to key 140, lock-bar top plate 170 that is rotatable around a shaft of bolt 130, and lock-bar bottom plate 180 that is affixed to bolt 130. When lock-activation top plate 120 is rotated, its attached key 140 acts to rotate lock-bar top plate 170 around a shaft of bolt 130 in a first direction, and lock-bar bottom plate 180 is rotated in the opposite direction to either lock jigging puck 101 to the sides of the slot in the truss-assembly when the X-shapes scissor action expands the X-shaped 170-180 combination or to unlock when the X-shaped 170-180 combination is relaxed or compressed to its neutral orientation.

FIG. 2B is a more detailed cross-section view of jigging puck assembly 101, across section plane B shown in FIG. 2A, primarily illustrating a cross section of lock-activation top plate 120, according to some embodiments of the present invention. In some embodiments, lock-activation top plate 120 includes a striking surface 121 configured to be struck by a hammer to rotate lock-activation top plate 120 to the locked position, and a striking surface 122 configured to be struck by a hammer to rotate lock-activation top plate 120 to the locked position. In other embodiments, some other tool, such as a wrench or even finger pressure can be used to rotate lock-activation top plate 120 to the locked or unlocked positions. n some embodiments, lock-activation top plate 120 includes a stop surface 123 that will be pressed against a corresponding surface 113 of base plate 110 to limit counterclockwise rotation towards the unlocked position, and a stop surface 124 that will be pressed against a corresponding surface 114 of base plate 110 to limit clockwise rotation towards the locked position. In some embodiments, lock-activation top plate 120 includes a rounded surface 128 that can travel along a corresponding surface 128 of base plate 110 on the right side of FIG. 1A as lock-activation top plate 120 is rotated, and a rounded surface 129 that can travel along a corresponding surface 119 of base plate 110 on the left side of FIG. 1A as lock-activation top plate 120 is rotated, both to help keep lock-activation top plate 120 relatively centered as lock-activation top plate 120 is being rotated. In some embodiments, lock-activation top plate 120 further includes a curved slot 126 in which bolt 130 travels (i.e., the slot 126 moves along a path guided by bolt 130), which also serves to help keep lock-activation top plate 120 relatively centered as lock-activation top plate 120 is being rotated.

FIG. 2C is a more detailed cross-section view of jigging puck assembly 101, across section plane C shown in FIG. 2A, primarily illustrating a cross section of lock-activation top plate 120, according to some embodiments of the present invention. The reference numbers are described above for FIG. 2B.

FIG. 2D is a more detailed cross-section view of jigging puck assembly 101, across section plane D shown in FIG. 2A, primarily illustrating a cross section of spacer plate 150 and rotating detent plate 160, according to some embodiments of the present invention. In some embodiments, rotating detent plate 160 includes a serrated or ridged features on the large arcuate outer-diameter surface 161 that interfaces with corresponding inner-diameter ridges on the inner surface 151 in the cutout of spacer plate 150. In some embodiments, rotating detent plate 160 includes a stop-surface 163 to limit the counterclockwise rotation of rotating detent plate 160 and a stop-surface 164 to limit the clockwise rotation of rotating detent plate 160. In some embodiments, rotating detent plate 160 includes a smaller-diameter curved surface 162 that mates against smaller-diameter curved surface 152 in the cutout of spacer plate 150, in order to guide the rotation of key 140 that is welded to the slot opening 165 rotating detent plate 160.

FIG. 2E is a more detailed cross-section view of jigging puck assembly 101, across section plane E shown in F FIG. 2A, primarily illustrating a cross section of a bottom portion of base plated 110, according to some embodiments of the present invention.

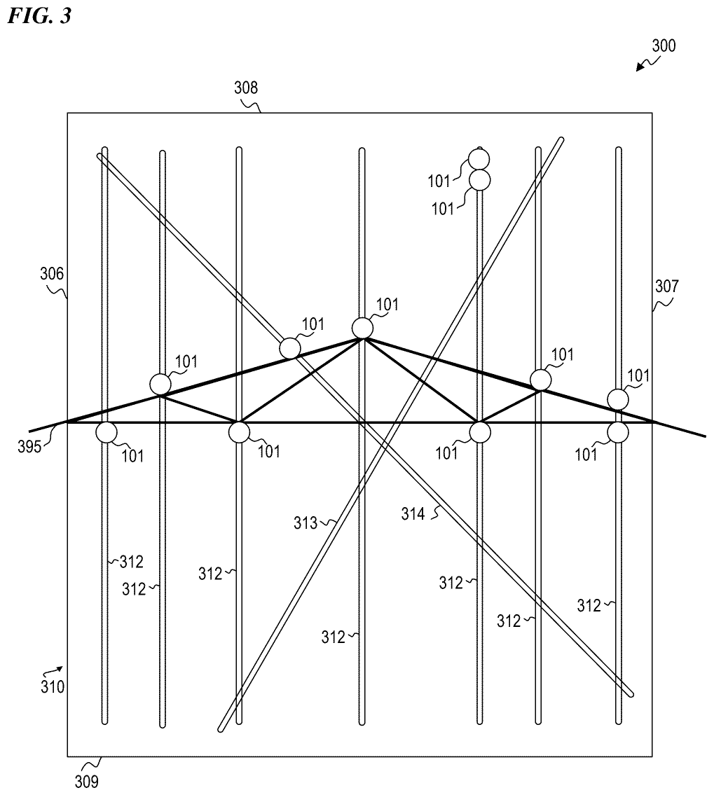

FIG. 2F is a more detailed cross-section view of jigging puck assembly 101, across section plane F shown in F FIG. 2A, primarily illustrating a cross section of lock-bar top plate 170 as well as the outer portion of lock-bar bottom plate 180, according to some embodiments of the present invention. In some embodiments, lock-bar top plate 170 includes a first key-interface surface 173 and a second key-interface surface 174, one or the other of which are engaged by rotation of key 140. When jigging puck 101 is activated to the locked configuration, first slot-interface surface 171 presses against one side of the truss-assembly table slot 312 (see FIG. 3 described below) and second slot-interface surface 172 presses against the opposite side of the same slot 312.

FIG. 2G is a more detailed a cross-section view of jigging puck assembly 101, across section plane G shown in FIG. 2A, primarily illustrating a cross section of lock-bar bottom plate 180, according to some embodiments of the present invention. In some embodiments, lock-bar bottom plate 180 includes a first key-interface surface 183 and a second key-interface surface 184, one or the other of which are engaged by rotation of key 140. When jigging puck 101 is activated to the locked configuration, first slot-interface surface 181 presses against one side of the truss-assembly table slot 312 (see FIG. 3 described below) and second slot-interface surface 182 presses against the opposite side of the same slot 312. Since lock-bar top plate 170 and lock-bar bottom plate 180 each rotate in opposite directions in a scissor or expanding-X configuration, there are resulting balanced and non-twisting forces applied to the opposite sides of slot 312, locking the jigging puck assembly 101 in place.

FIG. 3 is a top view of a truss-assembly table 300, according to some embodiments of the present invention. In some embodiments, truss-assembly table 300 includes a plurality of slots 312 running generally in parallel paths from near edge 308 to near edge 309. In some embodiments, the spacing of slots 312 between table edges 306 and 307 matches a spacing (left-to-right in FIG. 3) of the desired joints of truss 395 that is being assembled. In some embodiments, one or more additional slots 313 . . . 314 are provided at different angles to slots 312. In some embodiments, one or more additional slots are provided to accommodate different truss sizes. The joints of truss 395 are generally formed using nail plates (as is well known in the art), once all the truss lumber pieces are held in place by locked pucks 101. Once the spacing of all the pucks has been satisfactory established. A plurality of identical trusses can be quickly assembled one after another.

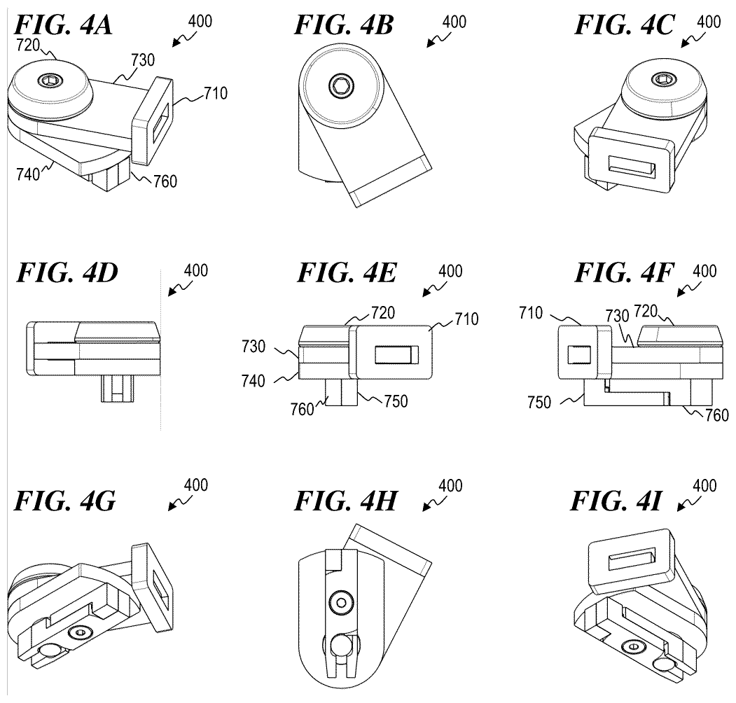

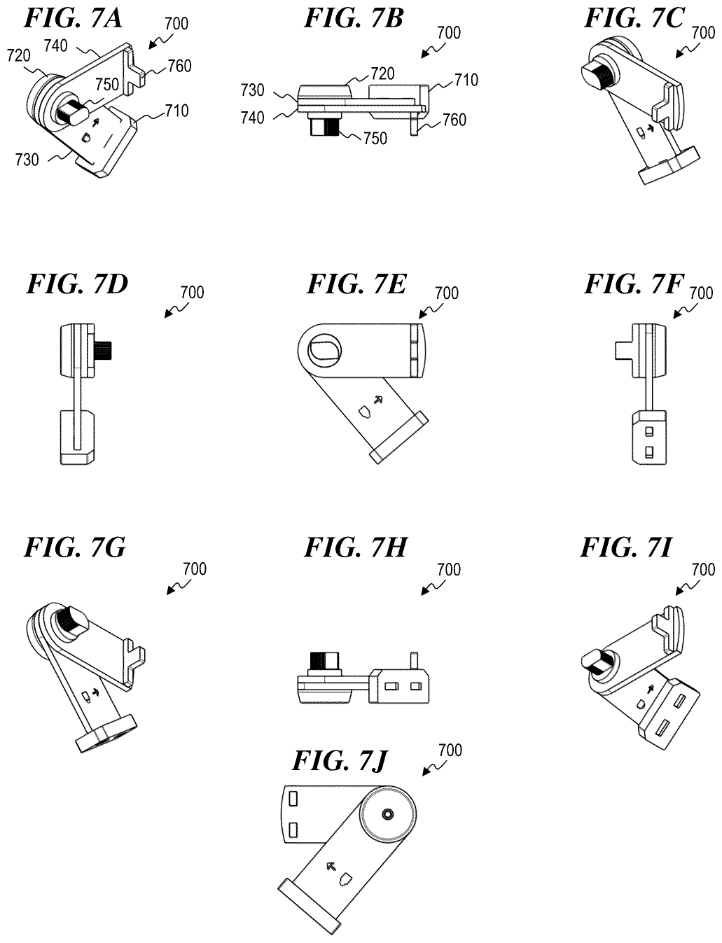

FIG. 4A is a top-left perspective view of a hammer-activated jigging puck 400, according to some embodiments of the invention. See FIG. 7A for explanation of the reference numbers.

FIG. 4B is a top view of hammer-activated jigging puck 400, according to some embodiments of the invention.

FIG. 4C is a top-right perspective view of hammer-activated jigging puck 400, according to some embodiments of the invention.

FIG. 4D is a rear-left elevation view of hammer-activated jigging puck 400, according to some embodiments of the invention.

FIG. 4E is a front elevation view of hammer-activated jigging puck 400, according to some embodiments of the invention. See FIG. 7A for explanation of the reference numbers.

FIG. 4F is a front-right elevation view of hammer-activated jigging puck 400, according to some embodiments of the invention.

FIG. 4G is a bottom-left perspective view of hammer-activated jigging puck 400, according to some embodiments of the invention.

FIG. 4H is a bottom view of hammer-activated jigging puck 400, according to some embodiments of the invention.

FIG. 4I is a bottom-right perspective view of hammer-activated jigging puck 400, according to some embodiments of the invention.

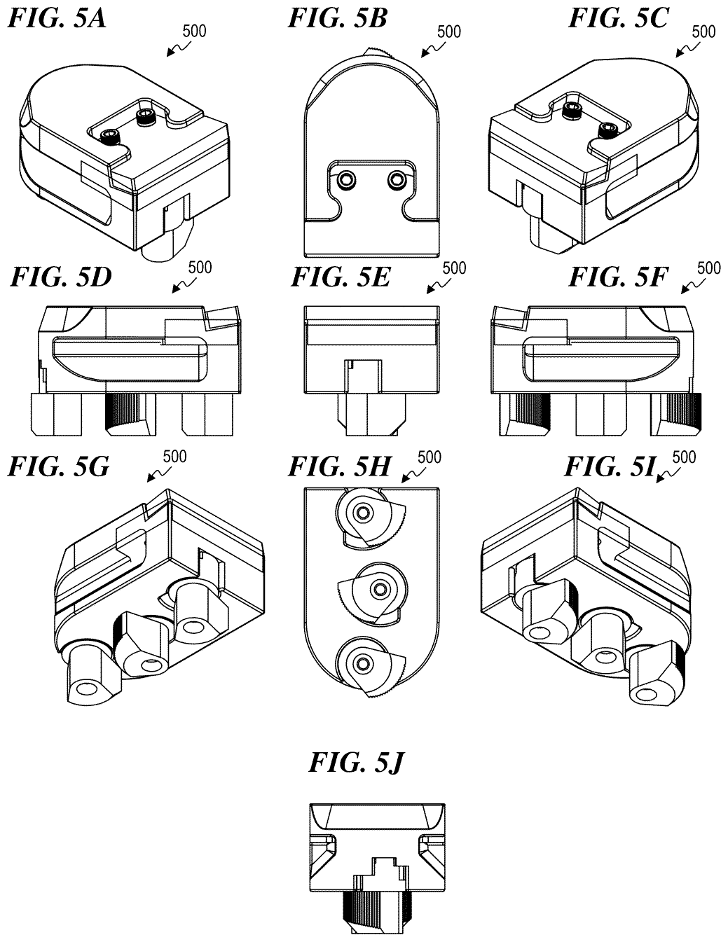

FIG. 5A is a top-left perspective view of a spring-loaded jigging puck 500, according to some embodiments of the invention.

FIG. 5B is a top view of spring-loaded jigging puck 500, according to some embodiments of the invention.

FIG. 5C is a top-right perspective view of spring-loaded jigging puck 500, according to some embodiments of the invention.

FIG. 5D is a left elevation view of spring-loaded jigging puck 500, according to some embodiments of the invention.

FIG. 5E is a front elevation view of spring-loaded jigging puck 500, according to some embodiments of the invention.

FIG. 5F is a right elevation view of spring-loaded jigging puck 500, according to some embodiments of the invention.

FIG. 5G is a bottom-left perspective view of spring-loaded jigging puck 500, according to some embodiments of the invention.

FIG. 5H is a bottom view of spring-loaded jigging puck 500, according to some embodiments of the invention.

FIG. 5I is a bottom-right perspective view of spring-loaded jigging puck 500, according to some embodiments of the invention.

FIG. 5J is a back elevation view of spring-loaded jigging puck 500, according to some embodiments of the invention.

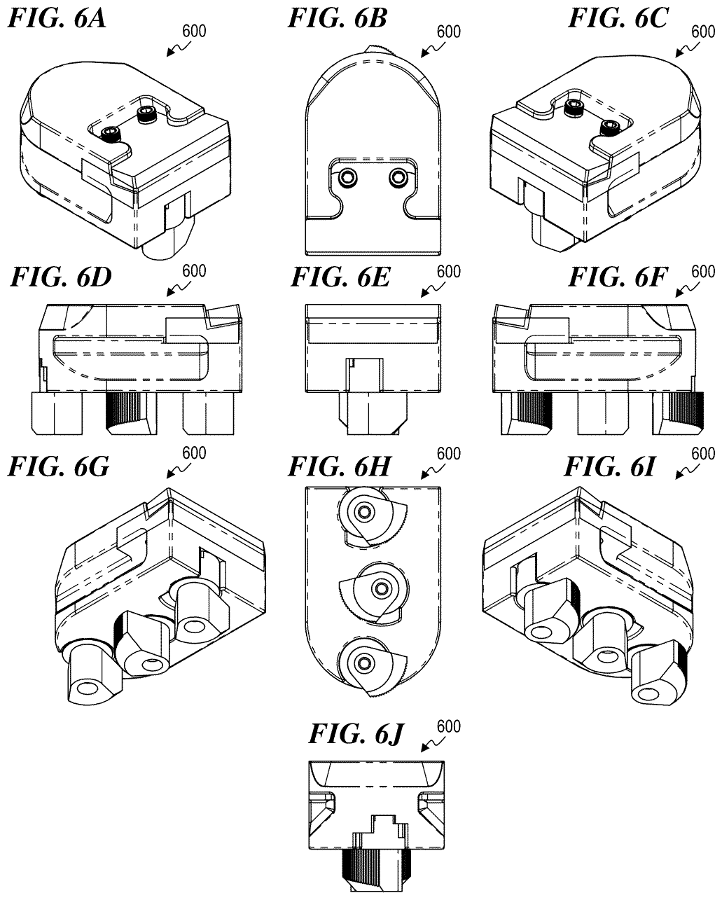

FIG. 6A is a top-left perspective view of a spring-loaded jigging puck 600 with dash-dot lines not part of the claimed design, according to some embodiments of the invention.

FIG. 6B is a top view of a spring-loaded jigging puck 600, according to some embodiments of the invention.

FIG. 6C is a top-right perspective view of spring-loaded jigging puck 600, according to some embodiments of the invention.

FIG. 6D is a left elevation view of spring-loaded jigging puck 600, according to some embodiments of the invention.

FIG. 6E is a front elevation view of spring-loaded jigging puck 600, according to some embodiments of the invention.

FIG. 6F is a right elevation view of spring-loaded jigging puck 600, according to some embodiments of the invention.

FIG. 6G is a bottom-left perspective view of spring-loaded jigging puck 600, according to some embodiments of the invention.

FIG. 6H is a bottom view of spring-loaded jigging puck 600, according to some embodiments of the invention.

FIG. 6I is a bottom-right perspective view of spring-loaded jigging puck 600, according to some embodiments of the invention.

FIG. 6J is a back elevation view of spring-loaded jigging puck 600, according to some embodiments of the invention.

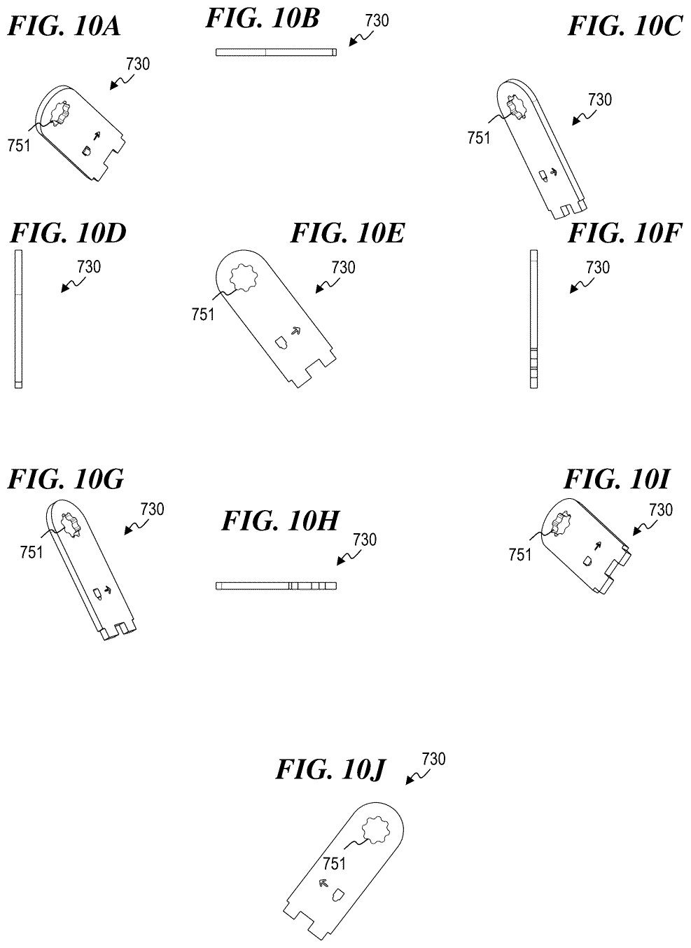

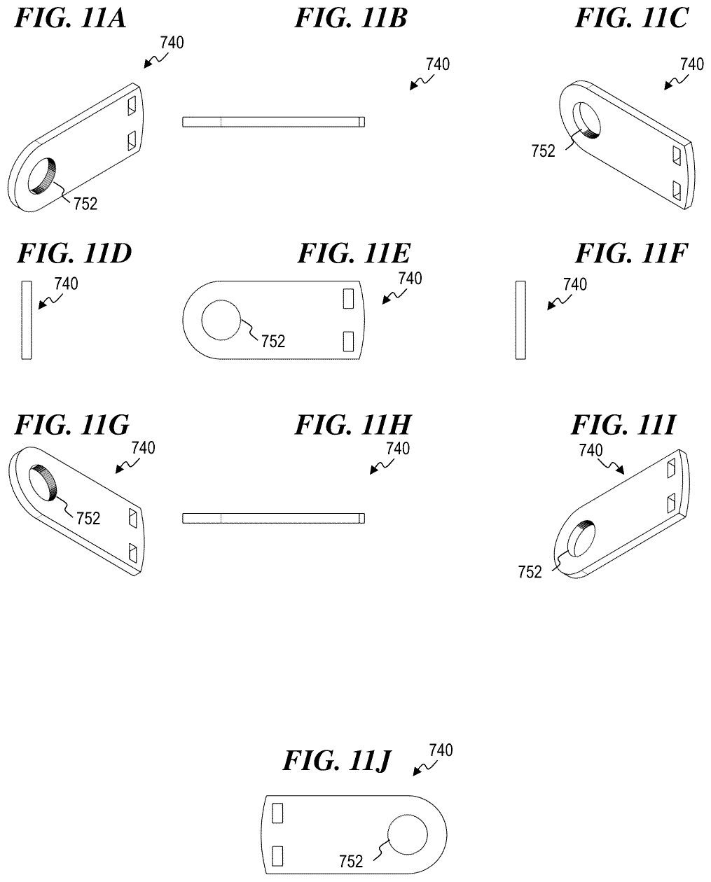

FIG. 7A is a top-left perspective view of a hammer-activated jigging puck 700, according to some embodiments of the invention. In some embodiments, hammer-activated jigging puck 700 includes hammer-blow-receiving block 710 that is welded to (or otherwise affixed to or made as part of) hammer plate 730, and torque plate 740 is welded to (or otherwise affixed to or made as part of) tongue tab 760. In some embodiments, puck top 720, is bolted to (or otherwise affixed to) flat-lock cam 750 after flat-lock cam 750 is placed through hole 751 and hole 752 (see FIGS. 10A and 11A). Once hammer-activated jigging puck 700 is welded and assembled as just described, a human worker can hammer on one end of hammer-blow-receiving block 710 to “lock” the hammer-activated jigging puck 700 to one of the slots 312, 313, . . . 314 in truss-assembly table 300 (also called a jigging table), according to some embodiments of the present invention. The end of hammer-activated jigging puck 700 that includes puck top 720 is pressed against on of the wood 2×4s (or other dimensional lumber) that make up the truss, and one end of the hammer-blow-receiving block 710 is hammered to lock it in place. Once the truss assembly is at least partially finished, the opposite end of the hammer-blow-receiving block 710 is hammered to unlock it.

FIG. 7B is a left elevation view of hammer-activated jigging puck 700, according to some embodiments of the invention.

FIG. 7C is a top-right perspective view of hammer-activated jigging puck 700, according to some embodiments of the invention.

FIG. 7D is a left elevation view of hammer-activated jigging puck 700, according to some embodiments of the invention.

FIG. 7E is a bottom view of hammer-activated jigging puck 700, according to some embodiments of the invention.

FIG. 7F is a right elevation view of hammer-activated jigging puck 700, according to some embodiments of the invention.

FIG. 7G is a bottom-left perspective view of hammer-activated jigging puck 700, according to some embodiments of the invention.

FIG. 7H is a right elevation of hammer-activated jigging puck 700, according to some embodiments of the invention.

FIG. 7I is a bottom-right perspective view of hammer-activated jigging puck 700, according to some embodiments of the invention.

FIG. 7J is a top view of hammer-activated jigging puck 700, according to some embodiments of the invention.

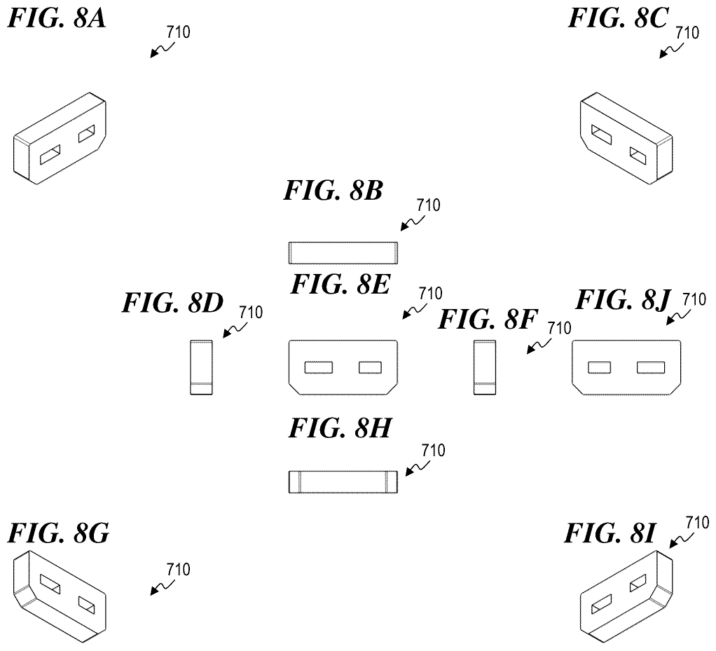

FIG. 8A is a top-left perspective view of hammer-blow-receiving block 710, according to some embodiments of the invention.

FIG. 8B is a left elevation view of hammer-blow-receiving block 710, according to some embodiments of the invention.

FIG. 8C is a top-right perspective view of hammer-blow-receiving block 710, according to some embodiments of the invention.

FIG. 8D is a left elevation view of hammer-blow-receiving block 710, according to some embodiments of the invention.

FIG. 8E is a bottom view of hammer-blow-receiving block 710, according to some embodiments of the invention.

FIG. 8F is a right elevation view of hammer-blow-receiving block 710, according to some embodiments of the invention.

FIG. 8G is a bottom-left perspective view of hammer-blow-receiving block 710, according to some embodiments of the invention.

FIG. 8H is a right elevation of hammer-blow-receiving block 710, according to some embodiments of the invention.

FIG. 8I is a bottom-right perspective view of hammer-blow-receiving block 710, according to some embodiments of the invention.

FIG. 8J is a top view of hammer-blow-receiving block 710, according to some embodiments of the invention.

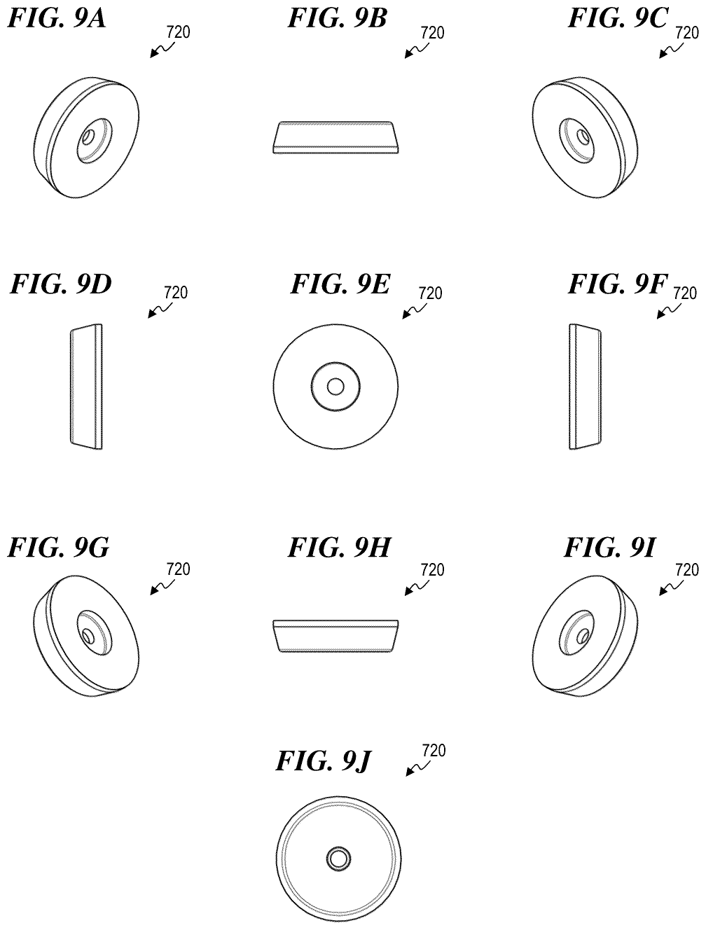

FIG. 9A is a top-left perspective view of puck top 720, according to some embodiments of the invention.

FIG. 9B is a left elevation view of puck top 720, according to some embodiments of the invention.

FIG. 9C is a top-right perspective view of puck top 720, according to some embodiments of the invention.

FIG. 9D is a left elevation view of puck top 720, according to some embodiments of the invention.

FIG. 9E is a bottom view of puck top 720, according to some embodiments of the invention.

FIG. 9F is a right elevation view of puck top 720, according to some embodiments of the invention.

FIG. 9G is a bottom-left perspective view of puck top 720, according to some embodiments of the invention.

FIG. 9H is a right elevation of puck top 720, according to some embodiments of the invention.

FIG. 9I is a bottom-right perspective view of puck top 720, according to some embodiments of the invention.

FIG. 9J is a top view of puck top 720, according to some embodiments of the invention.

FIG. 10A is a top-left perspective view of hammer plate 730, according to some embodiments of the invention.

FIG. 10B is a left elevation view of hammer plate 730, according to some embodiments of the invention.

FIG. 10C is a top-right perspective view of hammer plate 730, according to some embodiments of the invention.

FIG. 10D is a left elevation view of hammer plate 730, according to some embodiments of the invention.

FIG. 10E is a bottom view of hammer plate 730, according to some embodiments of the invention.

FIG. 10F is a right elevation view of hammer plate 730, according to some embodiments of the invention.

FIG. 10G is a bottom-left perspective view of hammer plate 730, according to some embodiments of the invention.

FIG. 10H is a right elevation of hammer plate 730, according to some embodiments of the invention.

FIG. 10I is a bottom-right perspective view of hammer plate 730, according to some embodiments of the invention.

FIG. 10J is a top view of hammer plate 730, according to some embodiments of the invention.

FIG. 11A is a top-left perspective view of torque plate 740, according to some embodiments of the invention.

FIG. 11B is a left elevation view of torque plate 740, according to some embodiments of the invention.

FIG. 11C is a top-right perspective view of torque plate 740, according to some embodiments of the invention.

FIG. 11D is a left elevation view of torque plate 740, according to some embodiments of the invention.

FIG. 11E is a bottom view of torque plate 740, according to some embodiments of the invention.

FIG. 11F is a right elevation view of torque plate 740, according to some embodiments of the invention.

FIG. 11G is a bottom-left perspective view of torque plate 740, according to some embodiments of the invention.

FIG. 11H is a right elevation of torque plate 740, according to some embodiments of the invention.

FIG. 11I is a bottom-right perspective view of torque plate 740, according to some embodiments of the invention.

FIG. 11J is a top view of torque plate 740, according to some embodiments of the invention.

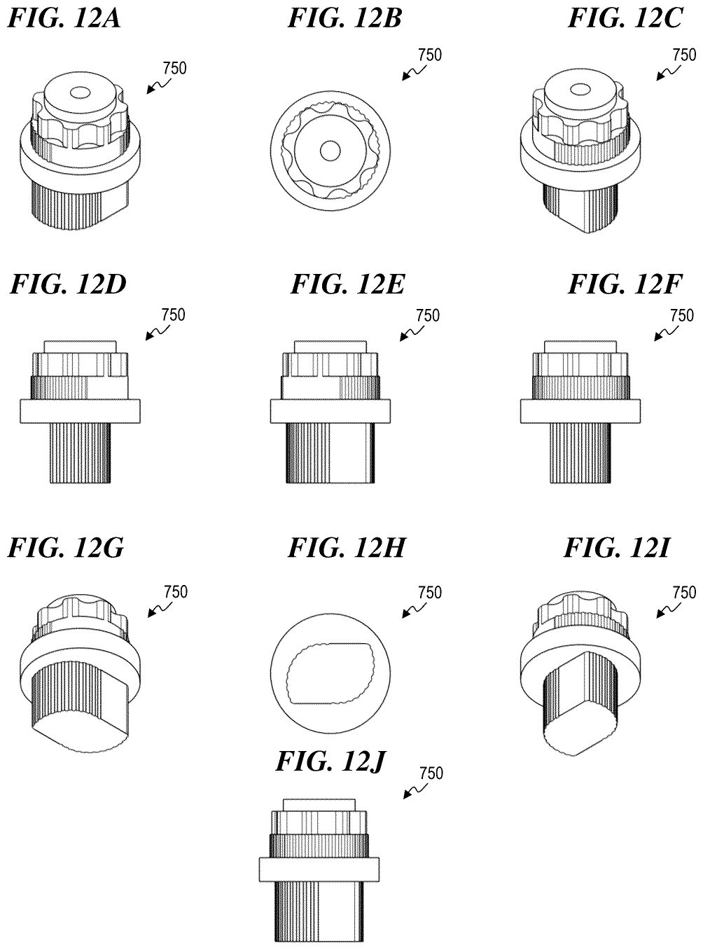

FIG. 12A is a top-left perspective view of flat-lock cam 750, according to some embodiments of the invention.

FIG. 12B is a left elevation view of flat-lock cam 750, according to some embodiments of the invention.

FIG. 12C is a top-right perspective view of flat-lock cam 750, according to some embodiments of the invention.

FIG. 12D is a left elevation view of flat-lock cam 750, according to some embodiments of the invention.

FIG. 12E is a bottom view of flat-lock cam 750, according to some embodiments of the invention.

FIG. 12F is a right elevation view of flat-lock cam 750, according to some embodiments of the invention.

FIG. 12G is a bottom-left perspective view of flat-lock cam 750, according to some embodiments of the invention.

FIG. 12H is a right elevation of flat-lock cam 750, according to some embodiments of the invention.

FIG. 12I is a bottom-right perspective view of flat-lock cam 750, according to some embodiments of the invention.

FIG. 12J is a top view of flat-lock cam 750, according to some embodiments of the invention.

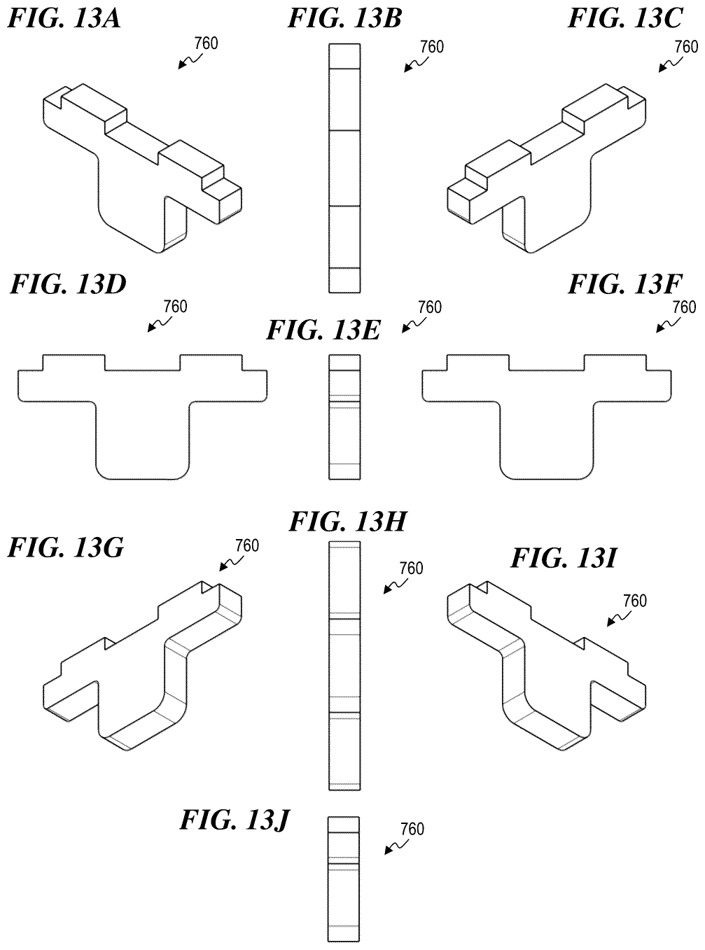

FIG. 13A is a top-left perspective view of tongue tab 760, according to some embodiments of the invention.

FIG. 13B is a left elevation view of tongue tab 760, according to some embodiments of the invention.

FIG. 13C is a top-right perspective view of tongue tab 760, according to some embodiments of the invention.

FIG. 13D is a left elevation view of tongue tab 760, according to some embodiments of the invention.

FIG. 13E is a bottom view of tongue tab 760, according to some embodiments of the invention.

FIG. 13F is a right elevation view of tongue tab 760, according to some embodiments of the invention.

FIG. 13G is a bottom-left perspective view of tongue tab 760, according to some embodiments of the invention.

FIG. 13H is a right elevation of tongue tab 760, according to some embodiments of the invention.

FIG. 13I is a bottom-right perspective view of tongue tab 760, according to some embodiments of the invention.

FIG. 13J is a top view of tongue tab 760, according to some embodiments of the invention.

In some embodiments, the present invention provides a hammer-activated jigging puck assembly 700 that includes: a hammer plate 730; a hammer-blow-receiving block 710 that is affixed to or formed as part of hammer plate 730, wherein hammer-blow-receiving block 710 includes a non-circular hole 751; a torque plate 740 having a tongue tab 760, wherein torque plate 740 includes a circular hole 751; a flat-lock cam 750; and a puck top 720 that is affixed to flat-lock cam 750 after flat-lock cam 750 is placed through hole 751 and hole 752, such that one end of the hammer-blow-receiving block 710 is hammered to lock it in place and an opposite end of the hammer-blow-receiving block 710 is hammered to unlock it.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A jigging puck assembly comprising:
a base plate 110;
a key 140 having a vertical rotational axis 149;
a lock-activation top plate 120 that is affixed to key 140;
a shoulder bolt 130 having a vertical bolt axis 139;
a detent plate 160 that is also affixed to key 140;
a spacer plate 150 that surrounds detent plate 160;
a lock-bar top plate 170 that is rotatable around a shaft of bolt 130; and
a lock-bar bottom plate 180 that is affixed to bolt 130.

2. The jigging puck assembly of claim 1, wherein base plate 110, key 140, lock-activation top plate 120, shoulder bolt 130, detent plate 160, spacer plate 150, lock-bar top plate 170, and lock-bar bottom plate are made of metal.

3. The jigging puck assembly of claim 1, wherein base plate 110, key 140, lock-activation top plate 120, shoulder bolt 130, detent plate 160, spacer plate 150, lock-bar top plate 170, and lock-bar bottom plate are made of steel.

4. The jigging puck assembly of claim 1, wherein key 140 has a vertical rotation axis 149, and key 140, detent plate 160, and lock-activation top plate 120 rotate as a unit around the vertical key rotation axis 149.

5. The jigging puck assembly of claim 1, wherein lock-bar top plate 170 and lock-bar bottom plate form a lower portion of jigging puck 101, which extends into a slot of a truss-assembly table, such that when lock-activation top plate 120 is rotated to a first unlock position, key 140 is in a neutral rotary position relative to lock-bar top plate 170 and lock-bar bottom plate 180 so that lock-bar top plate 170 and lock-bar bottom plate 180 are relatively aligned with one another and they are not urged against the sides of the slot into which jigging puck 101 is inserted, and at a time when an operator rotates lock-activation top plate 120 around the vertical key rotation axis 149, the lower portions 147 and 148 of key 140 press against respective portions of lock-bar top plate 170 and lock-bar bottom plate 180, forcing lock-bar top plate 170 and lock-bar bottom plate 180 to rotate in opposite directions around vertical bolt axis 139 to an X-shaped configuration with opposite ends of both lock-bar top plate 170 and lock-bar bottom plate 180 pressed against the sides of the slot each urged with relatively similar or the same force, effectively “locking” the jigging puck 101 in place in the slot.

6. The jigging puck assembly of claim 5, wherein lock-activation top plate 120 is operable to move to its locking position and to its unlocked position by rotating by a user's hand.

7. The jigging puck assembly of claim 5, wherein lock-activation top plate 120 is operable to move to its locking position and to its unlocked position by rotating by a hammer.

8. The jigging puck assembly of claim 5, wherein lock-activation top plate 120 is operable to move to its locking position and to its unlocked position by rotating by a wrench.

9. A hammer-activated jigging puck assembly 700 comprising:
a hammer plate 730;
a hammer-blow-receiving block 710 that is affixed to or formed as part of hammer plate 730, wherein hammer-blow-receiving block 710 includes a non-circular hole 751;
a torque plate 740 having a tongue tab 760, wherein torque plate 740 includes a circular hole 751;
a flat-lock cam 750; and
a puck top 720 that is affixed to flat-lock cam 750 after flat-lock cam 750 is placed through hole 751 and hole 752, such that one end of the hammer-blow-receiving block 710 is hammered to lock it in place and an opposite end of the hammer-blow-receiving block 710 is hammered to unlock it.
